(19) United States
(12) Patent Application Publication
(10) Pub. No.: US 2026/0320455 A1
(43) Pub. Date: Oct. 15, 2026

(54) QUANTUM EMBEDDING SYSTEM AND METHOD

(71) Applicant: Tanek Swain, Ashburn, VA (US)

(72) Inventor: Tanek Swain, Ashburn, VA (US)

(21) Appl. No.: 19/178,420

(22) Filed: Apr. 14, 2025

(51) Int. Cl. G06N 10/20

(52) U.S. Cl. CPC G06N 10/20

(57) ABSTRACT

A system and method for implementing quantum embeddings in a quantum computing environment are provided. The system receives input data and embedding parameters from a user, selects one of multiple quantum embedding types (e.g., Amplitude embedding, Angle embedding, or Basis embedding), generates a quantum circuit based on the selected embedding type and input parameters, creates a general quantum feature map using a parameter vector class, and interfaces with a kernel function to map the input data into quantum states. The system supports various embedding strategies, including Amplitude embedding with RY-CX and RZ-CRX schemes, Angle embedding with flexible gate sequences and parameter repetition options, and Basis embedding for binary data. The invention enables efficient implementation of quantum embeddings in Qiskit, facilitating the development and evaluation of quantum machine learning applications by providing a user-friendly interface for exploring different embedding techniques.

### TECHNICAL FIELD

The present invention relates generally to quantum computing, and more particularly to systems and methods for implementing quantum embeddings in quantum machine learning applications.

### BACKGROUND OF THE INVENTION

Quantum computing has emerged as a promising field with potential applications in various domains, including machine learning. Quantum machine learning (QML) combines principles of quantum computing with classical machine learning techniques to potentially achieve computational advantages over classical approaches. One crucial aspect of QML is the ability to efficiently map classical data into quantum states, a process known as quantum embedding.

Qiskit, a popular open-source framework for quantum computing, provides tools for implementing quantum algorithms and circuits. However, the current implementations for quantum embeddings in Qiskit are limited, with only the IQP (Instantaneous Quantum Polynomial) embedding readily available. Creating other types of quantum embeddings often requires extensive coding, significant computational resources, and coding of the circuit from scratch, especially as the number of qubits increases. This limitation hinders users from easily benchmarking and evaluating the performance of their QML applications using different embedding techniques. Therefore, there is a need for a more flexible and efficient system for implementing various quantum embedding techniques in Qiskit, enabling users to easily explore and compare different embedding strategies in their QML applications.

### SUMMARY OF THE INVENTION

In one aspect, the present invention provides a system for implementing quantum embeddings in a quantum computing environment. In one or more instances, this system may be implemented in a Qiskit environment. The system may include a processor and a memory storing instructions that, when executed by the processor, cause the system to: receive input data and embedding parameters from a user; select one of a plurality of quantum embedding types; generate a quantum circuit based on the selected quantum embedding type and the input parameters; create a general quantum feature map using a parameter vector class to map the input data into quantum states; and interface with a kernel function to further process those quantum states to feed into a machine learning model.

In another aspect, the present invention provides a method for implementing quantum embeddings in a quantum computing environment. In one or more instances, this system may be implemented in a Qiskit environment. The method may include: receiving input data and embedding parameters from a user; selecting one of a plurality of quantum embedding types; generating a quantum circuit based on the selected quantum embedding type and the input parameters; creating a general quantum feature map using a parameter vector class to map the input data into quantum states; and interfacing with a kernel function to further process those quantum states to feed into a machine learning model.

In yet another aspect, the present invention provides a non-transitory computer-readable medium storing instructions that, when executed by a processor, cause the processor to perform operations for implementing quantum embeddings in a quantum computing environment. The operations may include: receiving input data and embedding parameters from a user; selecting one of a plurality of quantum embedding types; generating a quantum circuit based on the selected quantum embedding type and the input parameters; creating a general quantum feature map using a parameter vector class to map the input data into quantum states; and interfacing with a kernel function to further process those quantum states to feed into a machine learning model.

### BRIEF DESCRIPTION OF THE DRAWINGS

The accompanying drawings, which are incorporated in and constitute a part of this specification, illustrate embodiments of the invention and, together with the description, serve to explain the principles of the invention.

FIG. 1 is a schematic diagram illustrating an overview of different quantum embedding types, according to an embodiment of the present invention.

FIG. 2 is a schematic diagram illustrating details of an Amplitude embedding unitary, according to an embodiment of the present invention.

FIG. 3 is a partial schematic diagram illustrating an RY-CX scheme used in Amplitude embedding, according to an embodiment of the present invention.

FIG. 4 is a partial schematic diagram illustrating an RZ-CRX scheme used in Amplitude embedding, according to an embodiment of the present invention.

FIG. 5 is a schematic diagram illustrating an Angle embedding with repeating parameters, according to an embodiment of the present invention.

FIG. 6 is a schematic diagram illustrating an Angle embedding without repeating parameters, according to an embodiment of the present invention.

FIG. 7 is a schematic diagram illustrating a Basis embedding, according to an embodiment of the present invention.

### DETAILED DESCRIPTION OF THE INVENTION

The present invention provides systems and methods for implementing various quantum embedding techniques in a quantum computing environment. In one or more instances, this system may be implemented in a Python programming environment. Furthermore, in one or more instances, this system may be implemented in a Qiskit environment, particularly within the Qiskit framework. The invention addresses the limitations of existing approaches by offering a flexible and efficient solution for creating quantum embeddings that can be easily integrated into quantum machine learning (QML) applications.

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well-known structures and components are shown in block diagram form in order to avoid obscuring such concepts.

The invention will be described in detail with reference to certain preferred embodiments thereof as illustrated in the accompanying drawings. In the following description, numerous specific details are set forth in order to provide a thorough understanding of the present invention. It will be apparent, however, to one skilled in the art, that the present invention may be practiced without some or all of these specific details. In other instances, well known process steps and/or structures have not been described in detail in order to not unnecessarily obscure the present invention. The features and advantages of the present invention may be better understood with reference to the drawings and discussions that follow.

Throughout this specification and the claims, the terms “comprise,” “comprising,” “include,” “including,” and the like are to be understood to imply the inclusion of stated elements but not the exclusion of any other elements. The term “exemplary” is used in the sense of “example” rather than “ideal” or “model.” As used herein, the terms “about” or “approximately” apply to all numeric values, whether or not explicitly indicated. These terms generally refer to a range of numbers that one of skill in the art would consider equivalent to the recited values (i.e., having the same function or result).

Before the present articles, systems, apparatuses, and/or methods are disclosed and described, it is to be understood that they are not limited to specific methods unless otherwise specified, or to particular materials unless otherwise specified, as such can, of course, vary. It is also to be understood that the terminology used herein is for the purpose of describing particular aspects only and is not intended to be limiting. Although any methods and materials similar or equivalent to those described herein can be used in the practice or testing of the present disclosure, example methods and materials are now described.

### a. Definitions

It is also to be understood that the terminology used herein is for the purpose of describing particular aspects only and is not intended to be limiting. As used in the specification and in the claims, the term “comprising” can include the aspects “consisting of” and “consisting essentially of.” Unless defined otherwise, all technical and scientific terms used herein have the same meaning as commonly understood by one of ordinary skill in the art to which this disclosure belongs. In this specification and in the claims which follow, reference will be made to a number of terms which shall be defined herein.

As used herein, the terms “about” and “at or about” mean that the amount or value in question can be the value designated some other value approximately or about the same. It is generally understood, as used herein, that it is the nominal value indicated ±10% variation unless otherwise indicated or inferred. The term is intended to convey that similar values promote equivalent results or effects recited in the claims. That is, it is understood that amounts, sizes, formulations, parameters, and other quantities and characteristics are not and need not be exact, but can be approximate and/or larger or smaller, as desired, reflecting tolerances, conversion factors, rounding off, measurement error and the like, and other factors known to those of skill in the art. In general, an amount, size, formulation, parameter or other quantity or characteristic is “about” or “approximate” whether or not expressly stated to be such. It is understood that where “about” is used before a quantitative value, the parameter also includes the specific quantitative value itself, unless specifically stated otherwise.

The terms “first,” “second,” “first part,” “second part,” and the like, where used herein, do not denote any order, quantity, or importance, and are used to distinguish one element from another, unless specifically stated otherwise. As used herein, the terms “optional” or “optionally” means that the subsequently described event or circumstance can or cannot occur, and that the description includes instances where said event or circumstance occurs and instances where it does not. For example, the phrase “optionally affixed to the surface” means that it can or cannot be fixed to a surface.

Moreover, it is to be understood that unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that an order be inferred, in any respect. This holds for any possible non-express basis for interpretation, including: matters of logic with respect to arrangement of steps or operational flow; plain meaning derived from grammatical organization or punctuation; and the number or type of aspects described in the specification.

It is understood that the apparatuses and systems disclosed herein have certain functions. Disclosed herein are certain structural requirements for performing the disclosed functions, and it is understood that there are a variety of structures that can perform the same function that are related to the disclosed structures, and that these structures will typically achieve the same result. The following description of various embodiments is merely exemplary in nature and is in no way intended to limit the disclosure, its application, or uses.

The following description is merely illustrative in nature and is in no way intended to limit the disclosure, its application, or uses. For purposes of clarity, the same reference numbers will be used in the drawings to identify similar elements. As used herein, the phrase “at least one of” A, B, and C should be construed to mean a logical (A or B or C), using a non-exclusive logical OR. It should be understood that steps within a method may be executed in different order without altering the principles of the present disclosure. As used herein, the term “module” may refer to, be part of, or include an Application Specific Integrated Circuit (ASIC), an electronic circuit, a processor (shared, dedicated, or group) and/or memory (shared, dedicated, or group) that execute one or more software or firmware programs, a combinational logic circuit, and/or other suitable components that provide the described functionality.

In one embodiment, the invention comprises three main components: (1) Amplitude embedding, (2) Angle embedding, and (3) Basis embedding. Each of these components is implemented as a separate class that generates quantum circuits for the respective embedding strategy. These classes utilize Qiskit's Parameter Vector( ) class to create general quantum gate parameters that are compatible with Qiskit's kernel function for automatic mapping of data into quantum states and further processing within a set parameter range.

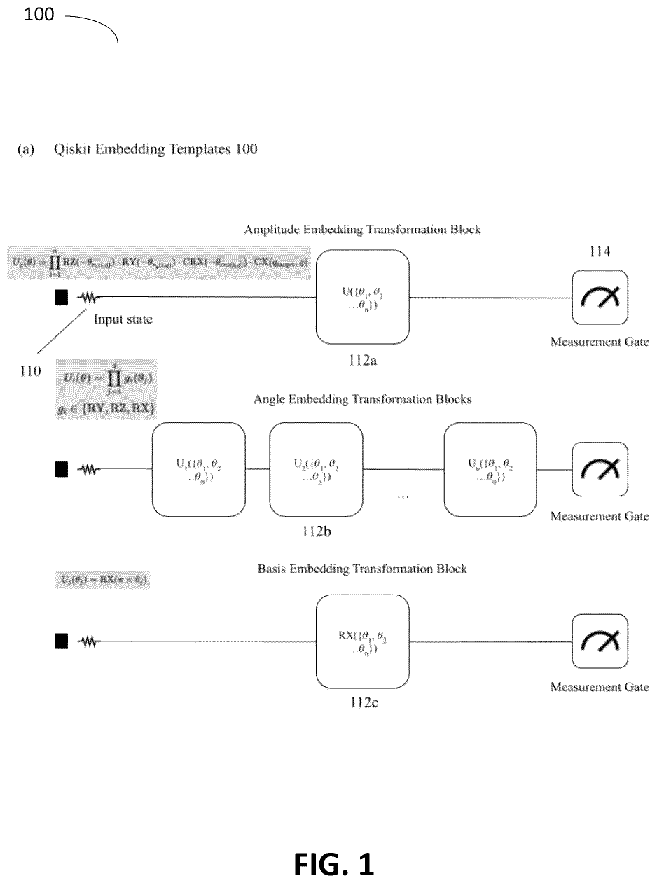

FIG. 1 illustrates an overview of the different quantum embedding types provided by the present invention. As shown in the figure, an input state 100 may be transformed by one of three embedding types: Amplitude embedding 112a, Angle embedding 112b, or Basis embedding 112c. Each embedding type applies different unitary transformations to the input state, resulting in a unique quantum state that represents the embedded classical data. The transformed state may then be measured 114 to obtain the desired output.

Amplitude Embedding: The Amplitude embedding component of the invention uses a scheme to maximally entangle the qubits with one another for the data to be preserved within the amplitude(s) of the quantum state.

Angle Embedding: The Angle embedding component of the invention uses a scheme where the data is embedded directly into a layer of quantum gates without additional computational interference to the data/parameters or the quantum state itself.

Basis Embedding: The Basis embedding component of the invention uses a scheme where binary data is aggregated with a constant within the circuit to preserve binary features during data conversion.

Furthermore, FIG. 1. outlines all of the embeddings and the amount of unitaries applied within each circuit. 100 outlines the input state, which can be scaled up to embed the data in multiple qubits, if necessary. There is only one unitary block for Amplitude embedding (112a) due to its complexity. In one or more instances the block can be further divided up into sub-schemes consisting of RY and CX gates, followed by RZ and CRX gates, multiple unitaries for Angle embedding (112b) to signify that multiple layers of gates can be applied within the circuit, and one unitary for Basis embedding (112c) to signify the single layer of RX gates. Each unitary takes in rotational parameters for quantum gates, most commonly the data point features themselves, with the exception of the Amplitude embedding. 114 outlines the measurement pulse applied to the embeddings, where if two embeddings are mirrored upon one another and measured, the inner product of the two data vectors is yielded, where 0 indicates orthogonal vectors and 1 indicates identical vectors, which is the main operation of the kernel function.

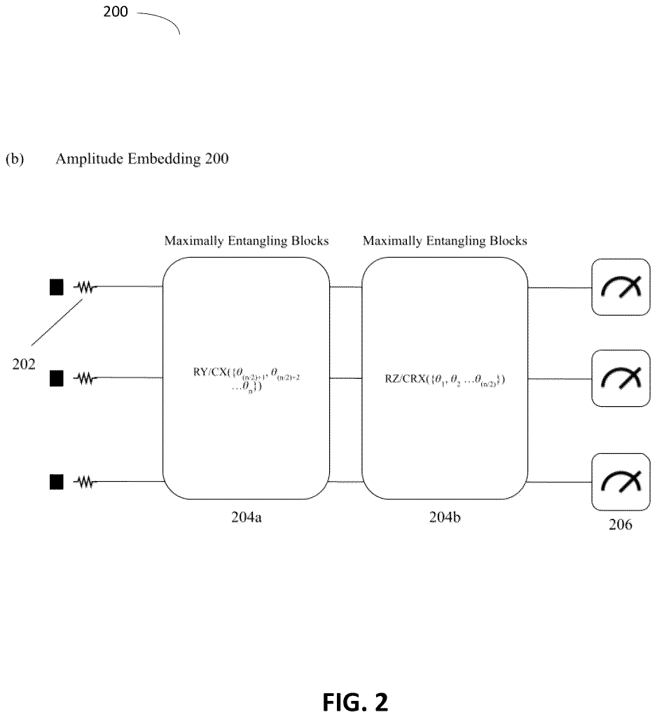

FIG. 2 illustrates the details of the Amplitude embedding unitary. The input state 202 undergoes a series of transformations through two main blocks: a first entangling block 204a consisting of RY and CX gates, followed by a second entangling block 204b consisting of RZ and CRX gates. The number of qubits required for Amplitude embedding is calculated based on the number of features in the input data vector by applying the second-degree logarithm to the number of features. The embedding process begins with a base case of one RY gate and one RZ gate with no entanglement gates on qubit n−1, where n is the number of qubits in a 0-indexing numbering system.

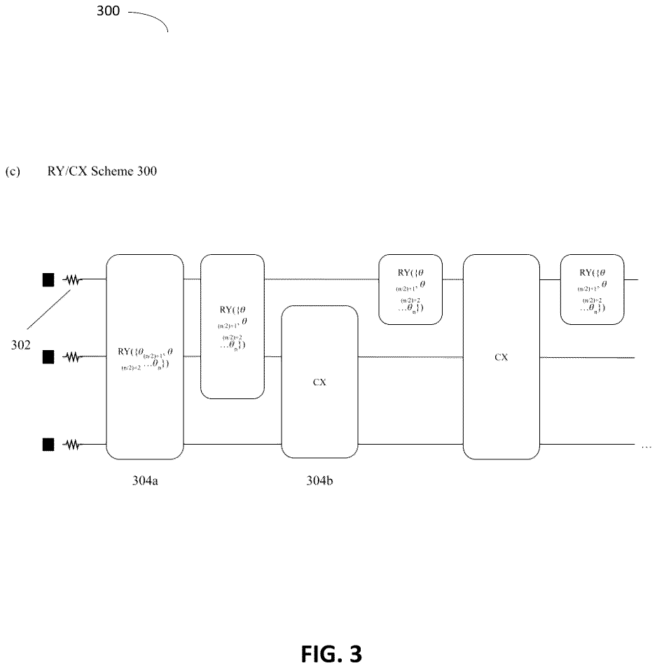

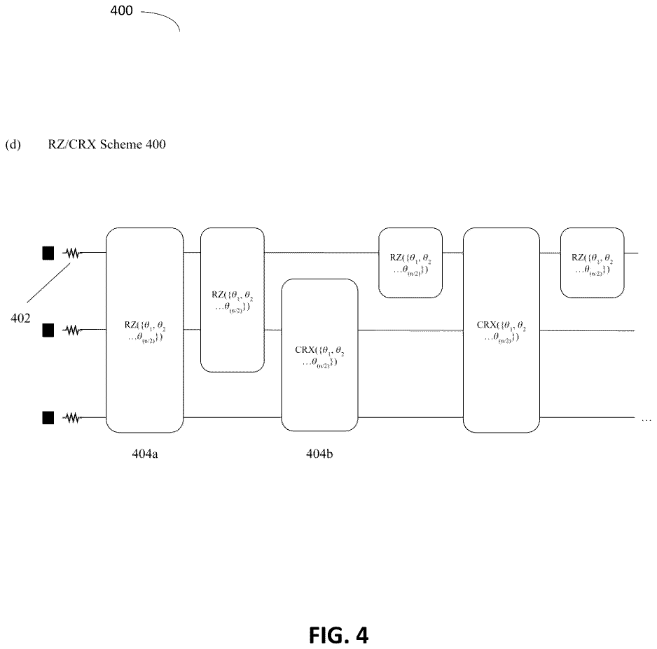

Furthermore, FIG. 2. further details the input state (202) having a set of unitaries applied to it, with the first unitary as an entangling block consisting of RY and CX gates (204a), followed by an entangling block consisting of RZ and CRX gates (204b). Note that to embed the data features into the amplitudes of the quantum states, the angles to create that quantum state have to be computed through external means and inputted into the general feature map in order. Furthermore, FIG. 2. details the Amplitude embedding scheme with 3 qubits; the Amplitude embedding scheme has to be scaled up if more data elements are present and fulfill the requirement to utilize Amplitude embedding. Increasing the number of qubits means that the embedding circuit will still start with applying an RY transformation on all qubits, and the circuit structure scales up in a similar manner with additional layers to accommodate the new qubits until the last gates are a CX gate from the lowest qubit to the highest qubit followed by an RY gate on the highest qubit (see FIG. 3. for more details). The same premise is repeated for the RZ-CRX scheme (see FIG. 4. for more details).

FIG. 3 illustrates the RY-CX scheme used in Amplitude embedding. The input state 302 undergoes a series of RY gate operations 304a, with the number of gates following a pattern of 2\hat{ }n per qubit (where n is the index of the qubit starting from the bottom qubit to the top in a 0-indexing numbering system). This is followed by CX gates 304b to maximally entangle the qubits with one another in an order reverse of that of the RY gates.

Furthermore, FIG. 3. further details the input state (302) going through the operations under the RY-CX scheme, with the amount of RY gates (304a) detailing a pattern of 2n gates per qubit (n is the index of the qubit starting from the bottom qubit to the top), and CX gates to maximally entangle the qubits with one another in an order reverse of that of the RY gates (304b). Since the CX gate does not take in a parameter, the indices of the angle vectors that correlate to the CX entanglement gates are skipped over.

FIG. 4 illustrates the RZ-CRX scheme used in Amplitude embedding. Similar to the RY-CX scheme, the input state 402 undergoes a series of RZ gate operations 404a, followed by CRX gates 404b to maximally entangle the qubits. The CRX gate parameters are added in designated indices highlighted by the Parameter Vector( ) class, in addition to the data features.

Furthermore, FIG. 4. further details the input state (402) going through the operations under the RZ-CRX scheme, with the amount of RZ gates (404a) detailing a pattern of 2n gates per qubit (n is the index of the qubit starting from the bottom qubit to the top), and CRX gates to maximally entangle the qubits with one another in an order reverse of that of the RZ gates (404b). CRX gate parameters have to be added in the designated indices highlighted by the ParameterVector( ) class in addition to the data features due to the need to specify that the CRX gates are not added if the parameters added by the RZ gates for a specific qubit is equivalent to 0, indicating that there is no further entanglement needed. This is not done for the RY-CX scheme since creating any quantum state requires some qubit operations along the y-axis unless the data vector inputted has all 0 elements.

### Angle Embedding:

The Angle embedding component allows users to input a series of gates from the set {RX, RY, RZ} that are applied to all qubits in the order specified by the user. This embedding type offers flexibility in terms of parameter repetition.

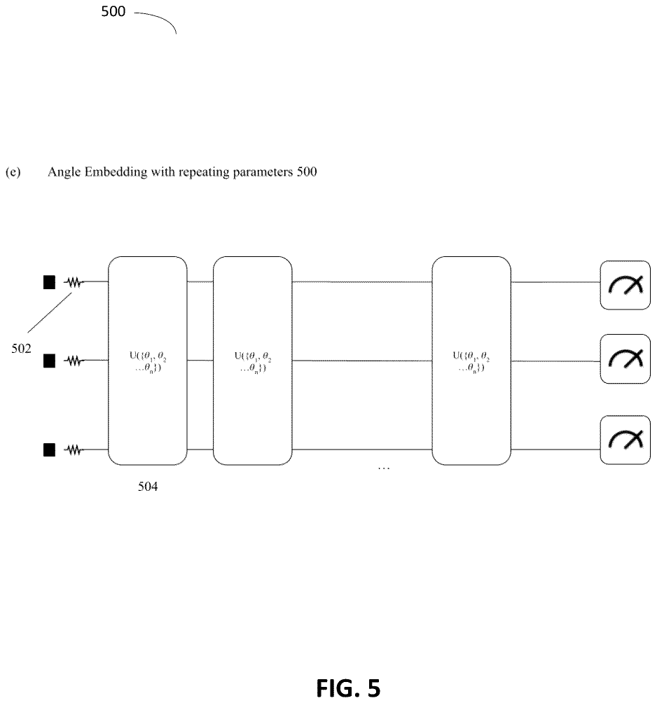

FIG. 5 illustrates an Angle embedding with repeating parameters. The input state 502 undergoes operations of the Angle embedding unitary as layers of sub-unitaries 504 specified by the user, with each layer inputting the same parameters on the same qubit a repeated number of times. Furthermore,

FIG. 5. describes the input state (502) undergoing the operations of the Angle embedding unitary as layers of sub-unitaries (504) specified by the user, each inputting the same parameters on the same qubit a repeated number of times. The traditional Angle embedding implementation may consist of only one of these layers, though with our invention it is possible to embed the same data repeatedly. Note that since Angle embedding does not have any entanglement blocks, it is traditionally used as a benchmark to determine if there are any possible classical methods to optimize a machine learning model that have not been discovered yet.

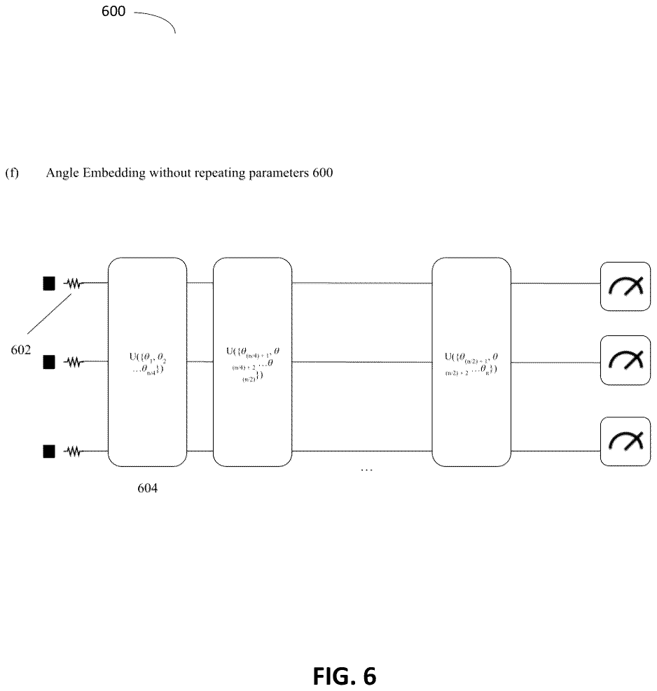

FIG. 6 illustrates an Angle embedding without repeating parameters. In this case, the input state (602) undergoes operations of the Angle embedding unitary as layers of sub-unitaries (604) specified by the user, with each layer inputting different parameters in a list order. This approach is particularly useful when there are too many data features to utilize a corresponding feasible number of qubits, as with this method, it is possible to stack up different data elements on the same qubits. Furthermore, FIG. 6. describes the input state (602) undergoing the operations of the Angle embedding unitary as layers of sub-unitaries (604) specified by the user, each inputting different parameters in a list order. This is a way to use Angle embedding if there are too many data features to be able to utilize a corresponding feasible number of qubits.

### Basis Embedding:

The Basis embedding component creates a singular layer of RX gates and multiplies the constant π to them. This embedding type is designed to convert binary data to its respective orthogonal states.

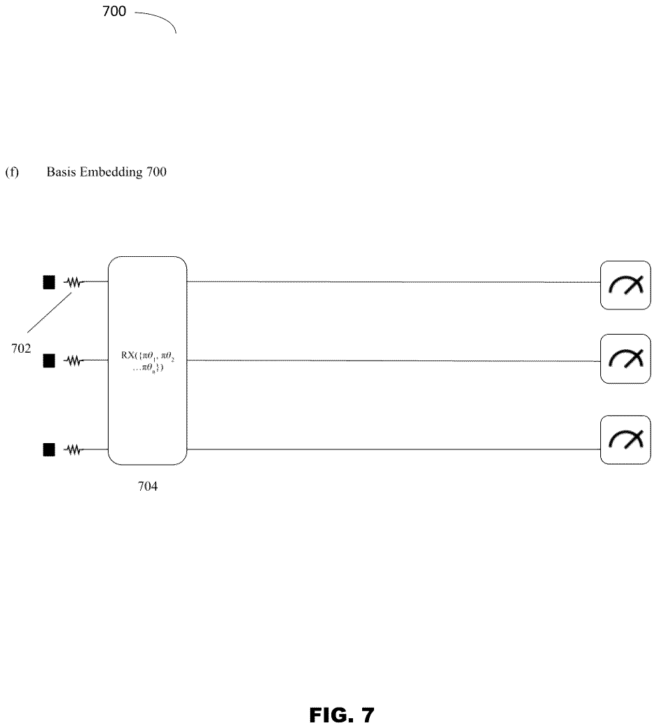

FIG. 7 illustrates the Basis embedding process. The input state 702 undergoes operations of the Basis embedding as a singular layer of RX gates 704, with parameters multiplied by the constant I to guarantee the creation of orthogonal states. Furthermore, FIG. 7. describes the input state (702) undergoing the operations of the Basis embedding as a singular layer of RX gates (704), inputting parameters that are multiplied by the constant π to guarantee the creation of orthogonal states. However, the orthogonal states generated can only be produced if the gate parameters themselves are binary. If float data is being used for QML applications, it is recommended to use Angle embedding, as it is more compatible with float data and scalable with layers.

In operation, the system receives input data and embedding type from a user. The system then validates the data compatibility with the selected embedding scheme and generates a quantum circuit based on the selected embedding type and input parameters. A general quantum feature map is created using the ParameterVector( ) class, which is then interfaced with Qiskit's kernel function to map the data into quantum states. The resulting quantum circuit or simulation can be executed as required by the user's QML application, and the results are returned to the user normally how results are returned with any Qiskit-provided kernel class.

The present invention offers several advantages over existing approaches. It provides a novel, efficient, and user-friendly method for implementing various discrete-variable quantum embeddings in Qiskit. The invention addresses the limitations of existing approaches and enables more comprehensive benchmarking and evaluation of QML applications. The generated quantum circuits are compatible with Qiskit's kernel function, allowing for seamless integration into existing QML workflows.

Furthermore, the invention supports feature scaling via Principal Component Analysis (PCA) before circuit creation and is compatible with further optimization using gradients or Simultaneous Perturbation Stochastic Approximation (SPSA) after circuit creation, given the user decides to implement a trainable set of gates, known as an ansatz, within the circuit. This flexibility allows users to fine-tune their quantum embeddings for specific QML applications.

In summary, the present invention provides a comprehensive solution for implementing quantum embeddings in Qiskit, enabling users to easily explore and compare different embedding strategies in their QML applications. By offering a range of embedding types and flexible parameter options, the invention facilitates more efficient and effective development of quantum machine learning algorithms.

It should be understood that the embodiments described herein are exemplary and that a person skilled in the art may make many variations and modifications without departing from the spirit and scope of the disclosure. All such variations and modifications are intended to be included within the scope of the disclosure as defined in the appended claims. While illustrative embodiments of the invention have been shown and described, variations and alternative embodiments may occur to those skilled in the art. Such variations and alternative embodiments may be made without departing from the scope of the invention as defined in the claims.

As used in this specification and the appended claims, the singular forms “a” and “an” indicate a single element, while “the” may refer back to single or plural referents. Unless defined otherwise, all technical and scientific terms used herein have the same meaning as commonly understood by one of ordinary skill in the art to which the disclosure pertains.

The above detailed description of exemplary and preferred embodiments is presented for the purposes of illustration and disclosure in accordance with the requirements of the law. It is intended to be exemplary but not exhaustive, and is not intended to limit the invention to the precise forms described, but only to enable others skilled in the art to understand how the invention may be suited for a particular use of implementation. No limitation is intended by the description of exemplary embodiments which may have included tolerances, feature dimensions, specific operating conditions, engineering specifications, or the like, and which may vary between implementations or with changes to the state of the art, and no such limitation should be implied therefrom.

Applicant has made this disclosure with respect to the current state of the art, but also contemplates advancements and that adaptations in the future may take into consideration those advancements in accordance with the then current state of the art. It is intended that the scope of the invention be defined by the Claims as written and equivalents as applicable. Reference to a claim element in the singular is not intended to mean “one and only one” unless explicitly so stated. No claim element herein is intended to be construed under the provisions of 35 U.S.C. 112(f), unless the element is expressly recited using the exact phrase “means for . . . ” and no method or process step herein is to be construed under the provisions of 35 U.S.C. section 112(f) unless the step, or steps, are expressly recited using the exact phrase “step(s) for . . . ”.

While aspects of the present disclosure can be described and claimed in a particular statutory class, such as the system statutory class, this is for convenience only and one of skill in the art will understand that each aspect of the present disclosure can be described and claimed in any statutory class. Unless otherwise expressly stated, it is in no way intended that any method or aspect set forth herein be construed as requiring that its steps be performed in a specific order. Accordingly, where a method claim does not specifically state in the claims or descriptions that the steps are to be limited to a specific order, it is no way appreciably intended that an order be inferred, in any respect. This holds for any possible non-express basis for interpretation, including matters of logic with respect to arrangement of steps or operational flow, plain meaning derived from grammatical organization or punctuation, or the number or type of aspects described in the specification.

Throughout this application, various publications can be referenced. The disclosures of these publications in their entireties are hereby incorporated by reference into this application in order to more fully describe the state of the art to which this pertains. The references disclosed are also individually and specifically incorporated by reference herein for the material contained in them that is discussed in the sentence in which the reference is relied upon. Nothing herein is to be construed as an admission that the present disclosure is not entitled to antedate such publication by virtue of prior present disclosure. Further, the dates of publication provided herein can be different from the actual publication dates, which can require independent confirmation.

The patentable scope of the present disclosure is defined by the claims, and can include other examples that occur to those skilled in the art. Such other examples are intended to be within the scope of the claims if they have structural elements that do not differ from the literal language of the claims, or if they include equivalent structural elements with insubstantial differences from the literal languages of the claims.

Insofar as the description above and the accompanying drawing disclose any additional subject matter that is not within the scope of the claims below, the disclosures are not dedicated to the public and the right to file one or more applications to claims such additional disclosures is reserved.

The foregoing descriptions of specific embodiments of the present invention have been presented for purposes of illustration and description. They are not intended to be exhaustive or to limit the present invention to the precise forms disclosed, and modifications and variations are possible in view of the above teaching. The exemplary embodiment was chosen and described to best explain the principles of the present invention and its practical application, to thereby enable others skilled in the art to best utilize the present invention and its embodiments with modifications as suited to the use contemplated.

It is therefore submitted that the present invention has been shown and described in the most practical and exemplary embodiments. It should be recognized that departures may be made which fall within the scope of the invention. With respect to the description provided herein, it is submitted that the optimal features of the invention include variations in size, materials, shape, form, function and manner of operation, assembly, and use. All structures, functions, and relationships equivalent or essentially equivalent to those disclosed are intended to be encompassed by the present invention.

It should be understood that the above-described embodiments are illustrative of only a few of the possible specific embodiments which can represent applications of the principles of the present disclosure. Numerous and varied other arrangements can be readily devised by those skilled in the art without departing from the spirit and scope of the disclosure. While specific embodiments of the invention have been described and illustrated, such embodiments should be considered illustrative of the invention only and not as limiting the invention as construed in accordance with the accompanying claims.

The previous description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein. It is to be understood that the foregoing description is not intended to limit the scope of the present disclosure. The present disclosure contemplates numerous variations, modifications, and adaptations that will become apparent to those skilled in the art upon reading and understanding the foregoing description. The scope of the present disclosure is defined by the appended claims and their legal equivalents.

What is claimed is:

1. A system for implementing quantum embeddings in a quantum computing environment, the system comprising:
a processor; and
a memory storing instructions that, when executed by the processor, cause the system to:
receive input data and embedding parameters from a user;
select one of a plurality of quantum embedding types, wherein the plurality of quantum embedding types comprises at least Amplitude embedding, Angle embedding, and Basis embedding;
generate a quantum circuit based on the selected quantum embedding type and the input parameters;
create a general quantum feature map using a parameter vector class; and
interface with a kernel function to map the input data into quantum states.

2. The system of claim 1, wherein the Amplitude embedding comprises:
calculating a number of qubits based on a number of features in the input data;
generating a first entangling block comprising RY and CX gates; and
generating a second entangling block comprising RZ and CRX gates.

3. The system of claim 2, wherein the first entangling block implements an RY-CX scheme comprising:
applying a pattern of 2\hat{ }n RY gates per qubit, where n is an index of the qubit; and
applying CX gates to maximally entangle the qubits in an order reverse of the RY gates.

4. The system of claim 2, wherein the second entangling block implements an RZ-CRX scheme comprising:
applying a pattern of 2\hat{ }n RZ gates per qubit, where n is an index of the qubit; and
applying CRX gates to maximally entangle the qubits in an order reverse of the RZ gates.

5. The system of claim 1, wherein the Angle embedding comprises:
receiving a user-specified series of gates from a set comprising RX, RY, and RZ gates;
applying the user-specified series of gates to all qubits in a specified order; and
selectively repeating parameters based on user preference.

6. The system of claim 5, wherein the instructions further cause the system to:
when parameter repetition is enabled, set a number of parameters compatible with the feature map to be equivalent to a number of qubits; and
when parameter repetition is disabled, set a number of parameters compatible with the feature map to be equivalent to a total number of gates in the generated quantum circuit.

7. The system of claim 1, wherein the Basis embedding comprises:
creating a single layer of RX gates;
multiplying a constant π to parameters of the RX gates; and
generating orthogonal states based on binary input data.

8. The system of claim 1, wherein the instructions further cause the system to:
validate data compatibility with the selected quantum embedding type prior to generating the quantum circuit.

9. The system of claim 1, wherein the instructions further cause the system to:
apply feature scaling via Principal Component Analysis (PCA) to the input data prior to generating the quantum circuit.

10. The system of claim 1, wherein the instructions further cause the system to:
apply optimization to the generated quantum circuit using at least one of gradient-based optimization or Simultaneous Perturbation Stochastic Approximation (SPSA).

11. A method for implementing quantum embeddings in a quantum computing environment, the method comprising:
receiving input data and embedding parameters from a user;
selecting one of a plurality of quantum embedding types, wherein the plurality of quantum embedding types comprises at least Amplitude embedding, Angle embedding, and Basis embedding;
generating a quantum circuit based on the selected quantum embedding type and the input parameters;
creating a general quantum feature map using a parameter vector class; and
interfacing with a kernel function to map the input data into quantum states.

12. The method of claim 11, wherein generating the quantum circuit for Amplitude embedding comprises:
calculating a number of qubits based on a number of features in the input data;
generating a first entangling block comprising RY and CX gates; and
generating a second entangling block comprising RZ and CRX gates.

13. The method of claim 11, wherein generating the quantum circuit for Angle embedding comprises:
receiving a user-specified series of gates from a set comprising RX, RY, and RZ gates;
applying the user-specified series of gates to all qubits in a specified order; and
selectively repeating parameters based on user preference.

14. The method of claim 11, wherein generating the quantum circuit for Basis embedding comprises:
creating a single layer of RX gates;
multiplying a constant π to parameters of the RX gates; and
generating orthogonal states based on binary input data.

15. The method of claim 11, further comprising:
validating data compatibility with the selected quantum embedding type prior to generating the quantum circuit.

16. The method of claim 11, further comprising:
applying feature scaling via Principal Component Analysis (PCA) to the input data prior to generating the quantum circuit.

17. The method of claim 11, further comprising: applying optimization to the generated quantum circuit using at least one of gradient-based optimization or Simultaneous Perturbation Stochastic Approximation (SPSA) given implementation of a user-written ansatz.

18. A non-transitory computer-readable medium storing instructions that, when executed by a processor, cause the processor to perform operations for implementing quantum embeddings in a quantum computing environment, the operations comprising:
receiving input data and embedding parameters from a user;
selecting one of a plurality of quantum embedding types, wherein the plurality of quantum embedding types comprises at least Amplitude embedding, Angle embedding, and Basis embedding;
generating a quantum circuit based on the selected quantum embedding type and the input parameters;
creating a general quantum feature map using a parameter vector class; and
interfacing with a kernel function to map the input data into quantum states.

19. The non-transitory computer-readable medium of claim 18, wherein the operations further comprise:
validating data compatibility with the selected quantum embedding type prior to generating the quantum circuit;
applying feature scaling via Principal Component Analysis (PCA) to the input data prior to generating the quantum circuit; and
applying optimization to the generated quantum circuit using at least one of gradient-based optimization or Simultaneous Perturbation Stochastic Approximation (SPSA).

20. The non-transitory computer-readable medium of claim 18, wherein generating the quantum circuit comprises:
for Amplitude embedding:
calculating a number of qubits based on a number of features in the input data,
generating a first entangling block comprising RY and CX gates, and
generating a second entangling block comprising RZ and CRX gates;
for Angle embedding:
receiving a user-specified series of gates from a set comprising RX, RY, and RZ gates,
applying the user-specified series of gates to all qubits in a specified order, and
selectively repeating parameters based on user preference; and
for Basis embedding:
creating a single layer of RX gates,
multiplying a constant π to parameters of the RX gates, and
generating orthogonal states based on binary input data.
